(19) United States
(12) Patent Application Publication
(10) Pub. No.: US 2025/0061393 A1
(43) Pub. Date: Feb. 20, 2025

(54) DYNAMIC CROP OUTCOME COMPUTATION ERROR CONTROL SYSTEM

(71) Applicant: Craig Tuttle, Scott City, KS (US)

(72) Inventor: Craig Tuttle, Scott City, KS (US)

(21) Appl. No.: 18/452,213

(22) Filed: Aug. 18, 2023

(51) Int. Cl. G06Q 10/0631; G06F 21/31; G06Q 50/02

(52) U.S. Cl. CPC G06Q 10/06313; G06F 21/31; G06Q 50/02

(57) ABSTRACT

Apparatus and associated methods relate to generate natural dependent responses. In an illustrative example, a selective nature response system (SNRS) may include multiple pre-event apportionment models (PEAMs). For example, the PEAMs may be used to generate a resource response for a resource operator and a resource controller of a resource as a function of a predicted resource outcome from the resource. A user, for example, may use a PEAM based on predicted resource responses corresponding to the PEAMs to the resource operator and the resource controller. An environmental dynamic package (EDP) may be generated as a function of the selected PEAM. At a percentage generation time, actual environmental information may be used to generate the actual environment dependent response for the resource controller and the resource operator. Various embodiments may advantageously determine an environment dependent response for the resource operator and the resource controller at a percentage generation time.

### CROSS-REFERENCE TO RELATED APPLICATIONS

The subject matter of this application may have common inventorship with and/or may be related to the subject matter of the following:
U.S. application Ser. No. 15/425,895, titled “Automated Farming System and Method,” filed by Craig B. Tuttle, on Feb. 6, 2017.

This application incorporates the entire contents of the foregoing application(s) herein by reference.

### TECHNICAL FIELD

Various embodiments relate generally to automatic resource outcome generations.

### BACKGROUND

Natural resources may sometimes be shared resources. For example, some utilization of the natural resources may occur between collaborating entities. For example, the collaborating entities may share the outcomes from the natural resources. In some examples, with the growing importance of technology and the internet, new opportunities for collaboration and resource sharing may be emerging. For example, some shared resources may include data and software resources. The sharing of resources in this way can lead to outputs for all involved.

As an illustrative example, a farm's rent may be determined based on a variety of parameters (e.g., previous years' rent, comparable rents in the area, landowner's preference).

### SUMMARY

Apparatus and associated methods relate to generate natural dependent responses. In an illustrative example, a selective nature response system (SNRS) may include multiple pre-event apportionment models (PEAMs). For example, the PEAMs may be used to generate a resource response for a resource operator and a resource controller of a resource as a function of a predicted resource outcome from the resource. A user, for example, may use a PEAM based on predicted resource responses corresponding to the PEAMs to the resource operator and the resource controller. An environmental dynamic package (EDP) may be generated as a function of the selected PEAM. At a percentage generation time, actual environmental information may be used to generate the actual environment dependent response for the resource controller and the resource operator. Various embodiments may advantageously determine an environment dependent response for the resource operator and the resource controller at a percentage generation time.

Various embodiments may achieve one or more advantages. For example, some embodiments may advantageously suggest environmental parameters to be included in the PEAMs based on a trained natural factor processing model. Some embodiments, for example, may advantageously include boundary conditions of resource response for the resource controller. For example, some embodiments may advantageously provide a continuous response apportionment between the resource controller and resource operator across a range of predicted resource outcomes.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary selective nature response system (SNRS) employed in an illustrative use-case scenario.

FIG. 2A, FIG. 2B, and FIG. 2C are block diagrams depicting an exemplary SNRS.

FIG. 3 is a block diagram depicting an exemplary factor generation model of an exemplary SNRS.

FIG. 4A and FIG. 4B depict an exemplary predicted output curve.

FIG. 5 depicts an exemplary method for training a machine learning model.

FIG. 6 depicts an exemplary pre-event apportion model (PEAM) selection method.

FIG. 7 depicts an exemplary resource outcome generation method.

Like reference symbols in the various drawings indicate like elements.

### DETAILED DESCRIPTION OF ILLUSTRATIVE EMBODIMENTS

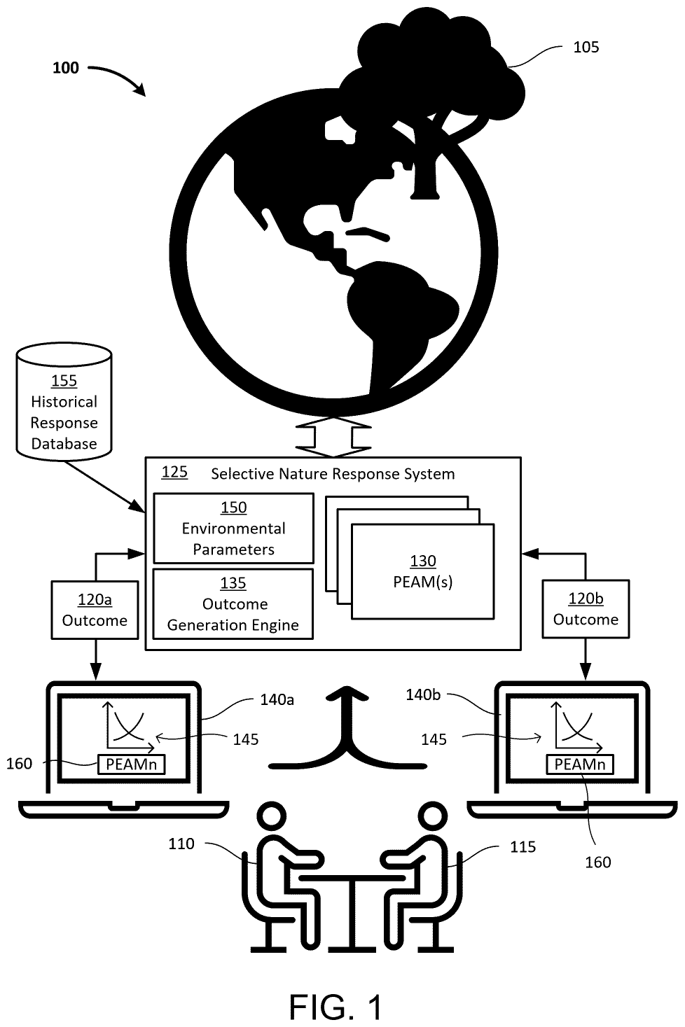

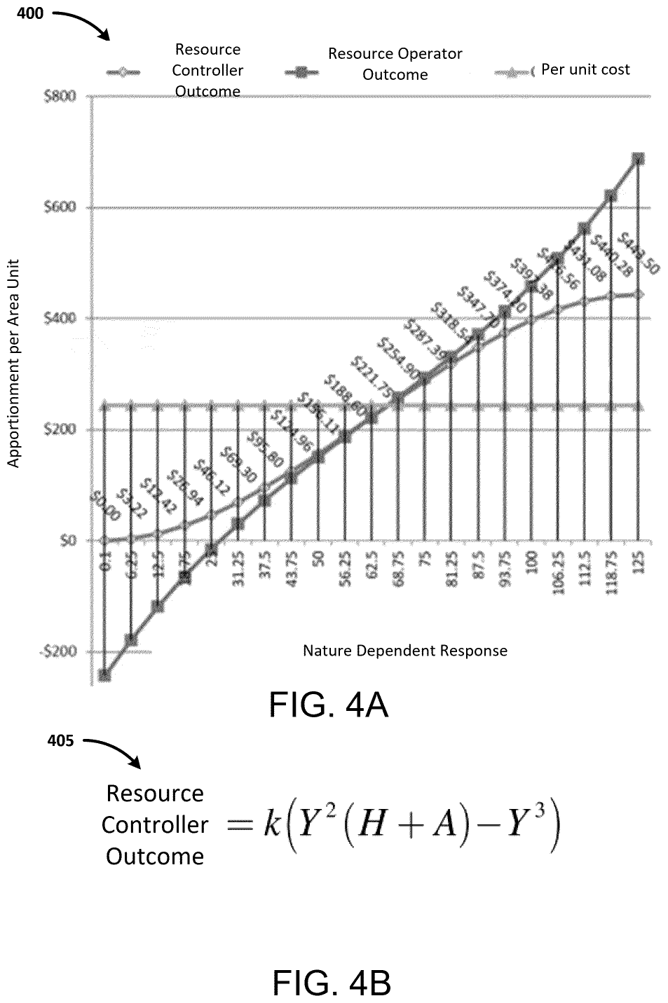

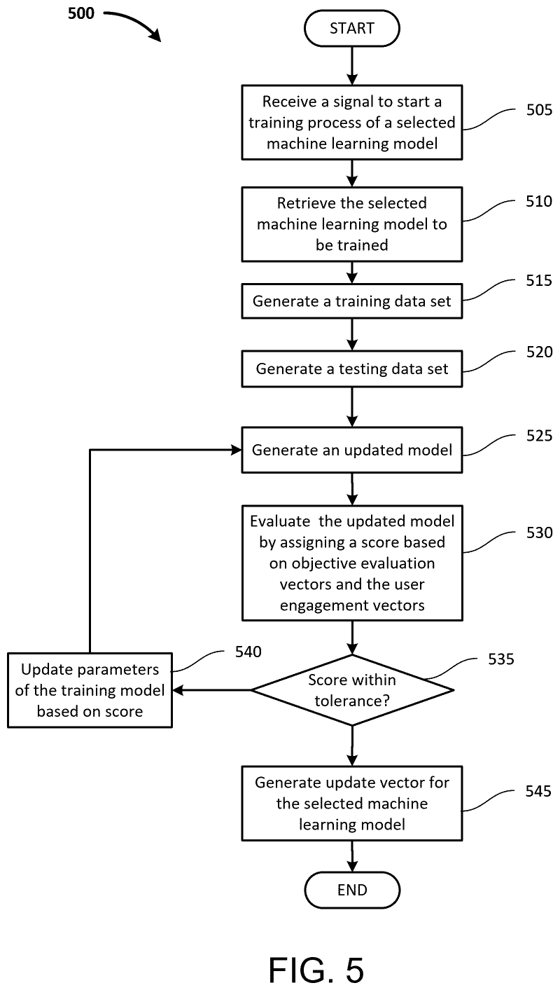

To aid understanding, this document is organized as follows. First, to help introduce discussion of various embodiments, a selective nature response system (SNRS) is introduced with reference to FIGS. 1-3. Second, that introduction leads to a description with reference to FIGS. 4A-B of some exemplary embodiments of an outcome generation model. Third, with reference to FIGS. 5-7, this document describes exemplary apparatus and methods useful for configuring, adjusting, and using the SNRS. Finally, the document discusses further embodiments, exemplary applications and aspects relating to the SNRS.

FIG. 1 depicts an exemplary selective nature response system (SNRS) employed in an illustrative use-case scenario. In this example, a nature response system 100 includes a nature dependent response 105. For example, the nature response system 100 may generate the nature dependent response 105 in a time period based on a natural occurrence (e.g., temperature, rainfall, weather patterns, pest occurrence, natural disease) in the time period. For example, the nature response system 100 may be a mine, and the nature dependent response 105 may be mineral extracted from the mine. For example, the nature response system 100 may be a farm (e.g., a farmland, a dairy farm, a cattle farm), and the nature dependent response 105 may be crops. For example, the nature response system 100 may be a fishery, and the nature dependent response 105 may be seafood.

In this example, the nature response system 100 also includes a resource controller 110 and a resource operator 115. For example, the resource controller 110 may be an owner of a resource (e.g., the nature response system 100). For example, the resource operator 115 may be a leaseholder of the nature response system 100 (e.g., a mine, a fishery, a farmland). The resource operator 115, for example, may be an operator of the nature response system 100. For example, the resource operator 115 may procure raw materials (e.g., seeds, fertilizers, water) and various equipment (e.g., tractors, harvesters, water systems) to generate the nature dependent response 105. For example, the resource operator 115 may also own his own resources (e.g., various equipment).

As shown, the resource controller 110 and the resource operator 115 receive an outcome 120a and an outcome 120b, respectively, from a SNRS 125. In some implementations, the outcomes 120a, 120b may include a signal indicating an amount or a percentage of the nature dependent response 105. For example, the outcomes 120a, 120b may include dollar amounts. For example, the outcomes 120a, 120b may include an equation in calculating an amount. For example, the outcomes 120a, 120b may include a ratio for dividing the nature dependent response 105 between the resource controller 110 and the resource operator 115.

The SNRS 125 generates, in this example, the outcomes 120a, 120b based on a preselected pre-event apportion model (PEAM). As shown, the SNRS 125 includes multiple PEAMs 130 and an outcome generation engine 135. The SNRS 125 may retrieve environmental parameters 150 associated with the nature response system 100, for example. For example, the environmental parameters 150 may include natural and/or economic conditions within a geographical threshold and time. In some examples, the environmental parameters 150 may include weather conditions of a current time period. For example, the environmental parameters 150 may include historical and/or present prices of the environmental parameters 150. In some examples, the environmental parameters 150 may include models for estimating current operating costs of the nature response system 100 in a proximate geographical area.

In some embodiments, in a percentage generation mode, the outcome generation engine 135 may apply the environmental parameters 150 to a pre-selected PEAM to generate the outcomes 120a, 120b. The pre-selected PEAM may be selected mutually by the resource controller 110 and the resource operator 115. In this example, the resource controller 110 and the resource operator 115 are using the computing device 140a and the computing device 140b, respectively to select one of the multiple PEAMs 130.

In this example, the resource controller 110 uses a computing device 140a and the resource operator 115 uses a computing device 140b to access the SNRS 125. For example, in a configuration mode, the computing device 140a and the computing device 140b may access the SNRS 125 to select one of the multiple PEAMs 130. As shown, the computing device 140a and the computing device 140b are displaying a curve 145. For example, the SNRS 125 may generate the curve 145 as a function of a currently selected PEAM 160. In some implementations, the curve 145 may display estimated outcomes 120a, 120b for the nature response system 100 based on a range of nature dependent responses. For example, the outcome 120a for the resource controller 110 may include a minimum when the nature dependent response 105 is low, and a variable portion when the nature dependent response 105 increases.

Various embodiments may advantageously allow the resource controller 110 to share a favorable response with the resource operator 115. In various embodiments, the curve 145 may be continuous. In some embodiments, the curve 145 may be non-continuous. For example, the curve 145 may be non-linear. For example, the curve 145 may be discrete. For example, the outcomes 120a, 120b for the resource controller 110 and the resource operator 115 may avoid abrupt changes across an output curve to advantageously generate a more predictable outcome estimate.

In some implementations, the curve 145 may include a predicted outcome 120b that may be estimated based on predicted environmental parameters 150. For example, the predicted environmental parameters 150 may be generated based on an artificial intelligence (AI) model. For example, the AI model may generate the predicted environmental parameters 150 based on historical environmental parameters 150 and the currently selected PEAM.

In some implementations, the PEAMs 130 may be trained models. For example, the PEAMs may be trained by an artificial neural network (ANN). For example, the PEAMs 130 may be trained by a deep neural network (DNN). As shown, the SNRS 125 is operably connected to a historical response database 155. For example, the historical response database 155 may be an external database. In some implementations, the historical response database 155 may be stored internally in the SNRS 125. For example, the historical response database 155 may include historical data of the nature dependent response 105 of the nature response system 100 and/or of a proximate area around the nature response system 100. For example, the historical response database 155 may also include environmental conditions (e.g., weather, economic conditions) corresponding to the historical response.

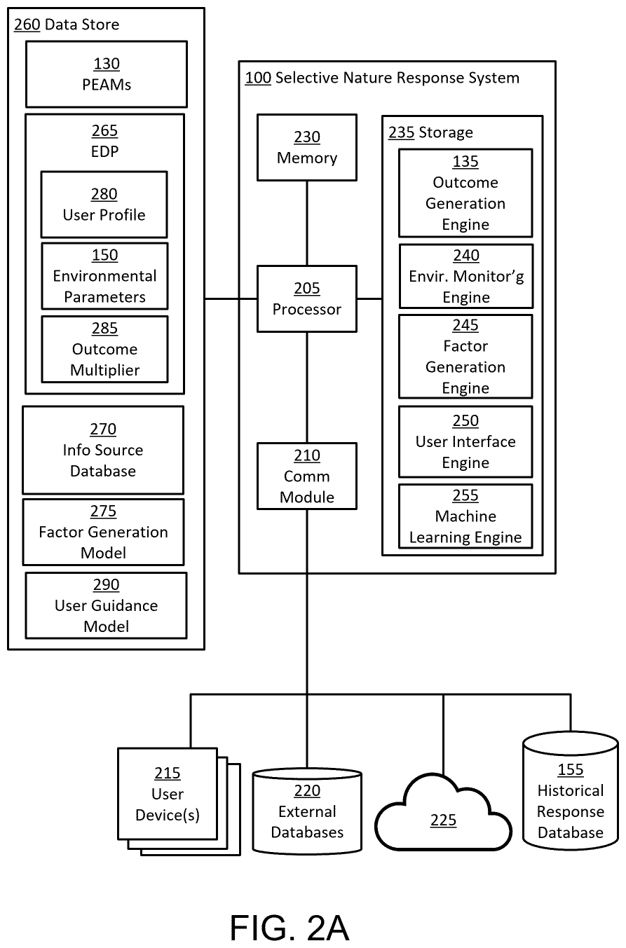

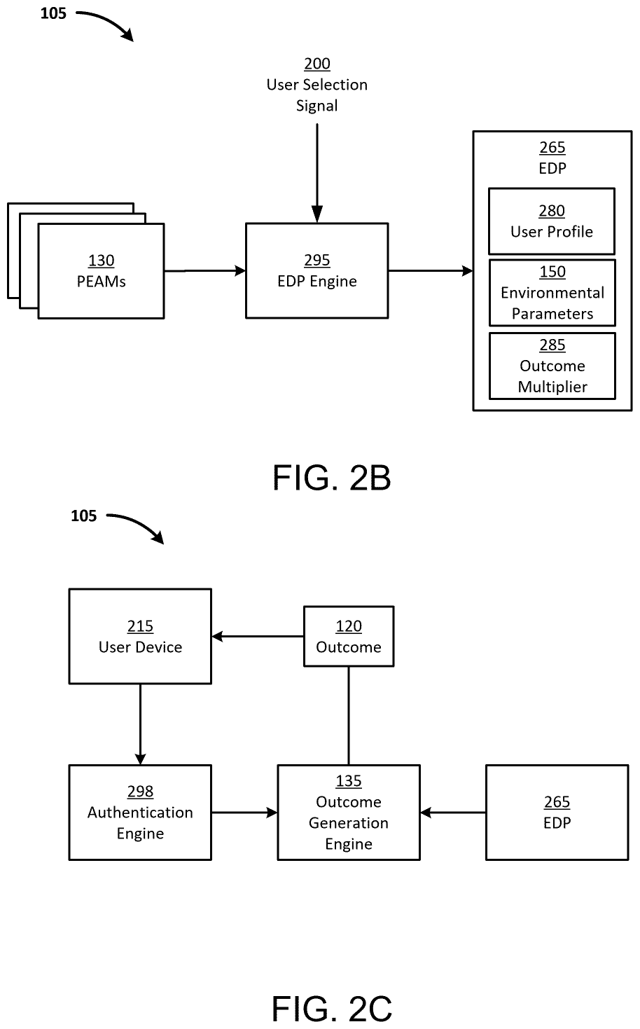

In some implementations, the outcome generation engine 135 may apply the environmental parameters 150 to a trained PEAM to generate a predicted nature dependent response 105. By comparing the predicted nature dependent response 105 and an actual response from the historical response database 155. The PEAMs 130 may be trained to predict a future nature dependent response 105 based on various predicted environmental parameters 150. Various embodiments of the AI model are further described in FIGS. 2-5. In various examples, the SNRS 125 may include a training algorithm to adjust parameters of the multiple PEAMs 130. In some implementations, the SNRS 125 may generate new PEAM based on user input.

In some implementations, the outcome 120b may be a remaining output after the outcome 120a is apportioned to the resource controller 110. For example, the multiple PEAMs 130 may include various user-selected factors associated with the outcome 120a. For example, some factors may be predetermined. For example, some factors may be automatically generated. In some implementations, the user-selected factors may be suggested by the SNRS 125 and confirmed by the resource controller 110 and/or the resource operator 115. For example, the user-selected factors may include a size and a geographical location of the nature response system 100.

In some implementations, the user-selected factor may include a time period (e.g., past 5 years, past 10 years, past 20 years, past 100 years) of which the outcome generation engine 135 may be used to estimate the outcomes 120a, 120b from. For example, a longer time period may advantageously be more stable. For example, data from older times may be less comprehensive. Upon selecting one of the multiple PEAMs 130, the SNRS 125 may generate the outcomes 120a, 120b to the resource controller 110 and the resource operator 115 at predetermined times and/or time intervals.

As an illustrative example without limitation, the nature response system 100 may be a farmland. For example, the outcome generation engine 135 may generate the outcomes 120a, 120b based on a pre-selected PEAM and the nature dependent response 105 of a current time period. For example, the outcome 120a may include a dollar amount of a proportion of an output (e.g., the nature dependent response 105) from the farmland (e.g., the nature response system 100). For example, for each year, the 125 may generate a payment amount from the resource operator 115 to the resource controller 110 based on an estimated output produced for a given tract of land. The estimated output, for example, may be generated based on the environmental parameters 150 associated with a geographical location of the nature response system 100. The payment, for example, may be generated by subtracting the outcomes 120b from the output.

In some implementations, the computing device 140a and the computing device 140b may be engaging with the SNRS 125 at various trigger points from time to time. For example, at the trigger point, the SNRS 125 may operate in a percentage generation mode to generate the outcomes 120a, 120b to the resource controller 110 and the resource operator 115. For example, one of the trigger points may be during a setup session before the resource controller 110 and the resource operator 115 begins their collaboration. In some implementations, the trigger points may include a predetermined time (e.g., 6 months, 2 years, 3 years, 5 years, 10 years) after commencement of the collaboration. In some implementations, the trigger points may be mathematically determined. For example, the trigger points may be triggered by the outcomes 120a, 120b. For example, when the outcome 120b drops below zero (e.g., due to natural disaster, draughts) consecutively for a predetermined time, the SNRS 125 may be triggered to notify the computing device 140a and the computing device 140b to re-select a PEAM from the multiple PEAMs 130.

In some examples, the environmental parameters 150 may be volatile over one or more years. For example, some environmental parameters 150 may be unpredictable prior to and during a response generation time period (e.g., a crop growing season). For example, natural factors affecting a price of a crop and an output of the crop (e.g., weather) may include uncontrollable factors. For example, the factors may include heating oil in winter, pest control spray in the summer, and other operating costs. In some examples, input factors may be dependent on minerals cost, oil cost, and/or water cost. In some examples, the factors may include rental cost (e.g., commercial facilities rental, equipment rental). For example, the price and the output may change the outcomes 120a, 120b in short notice (e.g., within days or a few weeks). For example, when one or both resource controller 110 and resource operator 115 are responsible for gathering information to determine the outcomes 120a, 120b, vast amount of variables (uncontrollable by the resource controller 110 and the resource operator 115) and conditions affecting the nature dependent response 105 may induce rough estimation and/or miscalculations. As a result, for example, the outcomes 120a, 120b created may be subjected to unfairness and dispute.

Accordingly, for example, the SNRS 125 may provide a technical solution to a technical problem for accurately generating the outcomes 120a, 120b. By retrieving real-time and/or historical information, for example, the SNRS 125 may generate the outcomes 120a, 120b for the resource controller 110 and the resource operator 115. In some implementations, the SNRS 125 may use the AI model to update the multiple PEAMs 130 based on, for example, newly included factors that may be important for determining the outcomes 120a, 120b.

In some examples, the resource controller 110 may predominate in negotiating an apportionment of the nature dependent response 105. For example, the resource controller 110 may be adverse to having a negative outcome when the nature dependent response 105 is not good. The SNRS 125 may, for example, provide a technical solution to a technical problem of having unpredictable outcomes with a multifactored PEAM by providing a continuous curve 145 for each of the multiple PEAMs 130. For example, the resource controller 110 may select based on the curve 145 and be assured about various possible outcomes as a function of the nature dependent response 105.

In some implementations, the PEAMs 130 may define various ways to calculate a work value of a period of time of the nature response system 100. For example, the nature response system 100 may generate value and incur expenses. In some examples, the PEAMs 130 may include an apportionment of an output (e.g., the nature dependent response 105) to the resource controller 110 and the resource operator 115. As an illustrative example without limitation, another resource operator 115 who may offer to operate a resource (e.g., in the same nature response system 100 or a similar nature response system 100) may be presented a PEAM based on the nature response system 100. For example, in a custom harvesting business, the PEAM may include a flat $/bushel, plus an additional payout per bushel for each bushel over a predetermined output (e.g., 25 bushel per acre). Accordingly, the resource operator 115 may dynamically receive a higher outcome when the nature dependent response 105 increases.

In some implementations, the environmental parameters 150 may include various things that are natural or manufactured. In some implementations, the environmental parameters may also include skills and time being used in producing an outcome. In various examples, production of things may include producing raw materials or finished products (e.g., commodities, retail products, houses for rent, services. In some examples, getting a cup of coffee at a local establishment may involve multiple things that may generate a return value to entities engaged in ventures for production of things.

Production, and/or outcomes produced from production activities, may require, for example, inputs of natural resources (e.g., sun light, rain, soil), inputs of other products, inputs of time of one or more entities (e.g., people, labor, workers), or a combination thereof. For example, sharing of the return value may historically include a poor distribution.

For example, the poor distribution may include a worker working to live and food to eat in exchange for their labor and skill (e.g., a time resource). For example, the poor distribution may include a manager of operations that generates in the return value a certain amount of currency or other compensation for their labor and skill. For example, assumptions may include on arbitrary notions about what compensation is given in return for those who provide labor and skill, about others who created inputs for products, and/or about owners of land and water and air or other natural resources that provide inputs to create outcomes of value.

For example, while dividing the nature dependent response 105, a banking lender may predict income for a client (e.g., who may be borrowing money for operating a resource) based on a PEAM mutually selected by a resource operator and a resource controller. For example, the predicted income may be used to determine loan payback. For landowners, for example, lenders may predict income for knowing ability to value the resource. The SNRS 125, for example, may be dependent on nature (e.g., including static features of soil, location, fertility). In some implementations, the SNRS 125 may also include dynamically changing parameters including other resources (e.g., light, water, mineralization of the soil particles). For example, dynamically changing parameters may change operations and/or reactions to the nature response system 100 on a daily basis to, for example, impact all the things in operating costs.

FIG. 2A, FIG. 2B, and FIG. 2C are block diagrams depicting an exemplary SNRS. As shown in FIG. 2A, the SNRS 125 includes a processor 205. The processor 205 may, for example, include one or more processors. The processor 205 is operably coupled to a communication module 210. The communication module 210 may, for example, include wired communication. The communication module 210 may, for example, include wireless communication. In the depicted example, the communication module 210 is operably coupled to user device(s) 215. For example, the user device(s) 215 may include the computing device 140a and the computing device 140b.

In the depicted example, the communication module 210 is operably coupled to the historical response database 155, external databases 220, and a cloud network 225. For example, the external databases 220 may include selected databases for retrieving the environmental parameters 150. In some implementations, the external databases 220 may include sources for generating an estimation of the nature dependent response 105 of the nature response system 100 in a current time period. The cloud network 225, for example, may supply information not included in the external databases 220. For example, the cloud network 225 may be the Internet. For example, the SNRS 125 may access the storage module 235 to obtain training data for configuring the PEAMs 130.

The processor 205 is operably coupled to a memory module 230. The memory module 230 may, for example, include one or more memory modules (e.g., random-access memory (RAM)). The processor 205 includes a storage module 235. The storage module 235 may, for example, include one or more storage modules (e.g., non-volatile memory). In the depicted example, the storage module 235 includes the outcome generation engine 135, an environmental monitoring engine (EME 240), a factor generation engine (FGE 245), a user interface engine (UIE 250), and a machine learning engine 255. The processor 205 further operably coupled to a data store 260. The data store, as depicted, includes the PEAMs 130, an environment data package (EDP 265), an information source database (ISD 270) and a factor generation model 275.

The outcome generation engine 135, for example, may generate the outcomes 120a, 120b as a function of the nature dependent response 105 and the EDP 265. In this example, the environmental parameters 150 is included in the EDP 265. The EDP 265 further includes a user profile 280 and an outcome multiplier 285. In some implementations, the outcome generation engine 135 may retrieve the EDP 265 based on an identification of the user and/or the nature response system 100. For example, the user profile 280 may include an associated nature response system 100 for a corresponding resource controller 110 and resource operator 115.

In some implementations, based on a user selection of one of the PEAMs 130 and selected factors including time and location, the system can dynamically generate the EDP 265. The outcome multiplier 285 may be applied to the nature dependent response 105 to generate an apportionment for the resource controller 110 and the resource operator 115, for example.

In some implementations, in a configuration time, a user (e.g., the resource controller 110 and/or the resource operator 115) may configure the user profile 280 based on user input using the device(s) 215. The outcome multiplier 285, for example, may be generated based on a selected PEAM. In some implementations, the outcome generation engine 135 may apply the environmental parameters 150 and the outcome multiplier 285 to the nature dependent response 105 to generate the outcomes 120a, 120b.

In some implementations, the user profile 280 may include a geographical location of the nature response system 100. For example, the user profile 280 may include a risk tolerance level of the resource controller 110 and/or the resource operator 115. For example, the user profile 280 may include pre-selected factors that may be important for selecting the PEAMs 130. In some implementations, based on the pre-selected factors, the UIE 250 may display a filtered set of the PEAMs 130 at the device(s) 215 for selection. For example, the outcome generation engine 135 may use the geographical location and historical environmental parameters 150 to predict whether any of the PEAMs 130 satisfies the user's requirements.

In some examples, the user may input boundary conditions for filtering the multiple PEAMs 130. For example, a bank of the resource controller 110 may impose a minimum outcome for the nature response system 100. In some implementations, the resource controller 110 may adjust the user-selected factors to produce a predicted outcome complying to the bank's requirements.

The EME 240, in some implementations, may access various data sources to retrieve environmental parameters 150. For example, the environmental parameters 150 may include climate, weather patterns, rainfall, soil type, types of natural resources (e.g., land, soil, crops, farming practices), and/or other factors affecting the nature dependent response 105. By applying the environmental parameters 150, for example, the outcome generation engine 135 may find values suitable for a selected PEAM to generate a predicted outcome of a PEAM or an actual outcome for the nature dependent response 105. For example, the EME 240 may retrieve historical environmental parameters 150. For example, the EME 240 may retrieve the environmental parameters 150 for a present time period. In this example, the EME 240 may retrieve the environmental parameters 150 from the external databases 220. The EME 240 may, for example, also access the storage module 235 based on a set of authenticated (e.g., verified, compliant) sources stored in the ISD 270. In some implementations, the ISD 270 may list sources and links corresponding to multiple data sources to generate the outcomes 120a, 120b and/or intermediate input (e.g., data for operating expenses, data for generating suggested factors to the user device(s) 215, data for training a machine learning model).

The FGE 245, for example, may generate suggested factors for user-selection. In some implementations, the FGE 245 may include a user interface for manually configuring the factor generation model 275. For example, an administrative user may compile a set of factors required by various stakeholders (e.g., creditors, banks, insurer, operators, controllers) to generate the factor generation model 275. In some implementations, the FGE 245 may generate the suggested factors based on the factor generation model 275. For example, the factor generation model 275 may be a large language model (LLM) that may be trained in artificial intelligence (AI) for suggesting factors based on, for example, importance, global and/or local usage, occurrence intensity, current research models, or a combination thereof. For example, the FGE 245 may transmit the generated suggested factors to the UIE 250 to be displayed at the device(s) 215.

In some implementations, the UIE 250 may interactively use the suggested factors to guide the user in selecting the PEAMs 130. For example, the data store 260 may further include a user guidance model (UGM 290). For example, the UGM 290 may be configured to generate questions and answers using a trained LLM to guide the user in a selection process. For example, the UGM 290 may, based on user input (e.g., in natural language), generate output PEAMs with the curve 145 that may fit criterion defined in the user input. For example, the UGM 290 may also generate (e.g., text-based, image-based, voice, and/or video) explanations of various advantages and disadvantages of a displayed PEAM.

The machine learning engine 255, for example, may be used to train PEAMs 130. For example, the machine learning engine 255 may use historical output (e.g., historical nature dependent response 105) and historical environmental parameters 150 of various factors to train the PEAMs 130. For example, the machine learning engine 255 may train the PEAMs to achieve a predetermined accuracy based on the historical nature dependent response 105 (e.g., for one or more geographical locations).

In some implementations, the machine learning engine 255 may also be the factor generation model 275 and the UGM 290. For example, the factor generation model 275 and the UGM 290 may be pre-trained in generative AI to advantageously save training cost and time. For example, the machine learning engine 255 may re-train the factor generation model 275 and the UGM 290 based on their performance in specified tasks of generating related factors and guidance for the PEAM selection process.

In various implementations, a selective nature response system (e.g., the SNRS 125) may include a number of user selectable models (e.g., the PEAMs 130). For example, each of the PEAMs 130 may be a trained model. For example, the PEAMs 130 may generate an output (e.g., the outcomes 120a, 120b, the curve 145) based on a set of predetermined parameters associated with a resource (e.g., the nature response system 100).

Based on a user selection of one of the models and selected parameters including time and location, the system can dynamically generate a data structure (e.g., the EDP 265) including the user selected model, a predicted nature dependent response (e.g., a predicted response of the nature dependent response 105) of the resource, and an apportionment of the response between a first user (e.g., the resource controller 110) and a second user (e.g., the resource operator 115). At a predetermined time, a finite apportionment of an actual nature dependent response (e.g., the nature dependent response 105 during a predetermined time period) may, for example, be generated based on the data structure selected between the first user and the second user.

FIG. 2B shows an exemplary SNRS for generating the EDP 265. In this example, the nature dependent response 105 includes an EDP engine 295. For example, the storage module 235 may include the EDP engine 295. As shown, the EDP engine 295 receives a user selection signal 200. For example, the user selection signal 200 may be received through the UIE 250 from the device(s) 215. For example, the user selection signal 200 may include a selection of one of the PEAMs 130.

After receiving the user selection signal 200, for example, the EDP engine 295 may generate the EDP 265. In some implementations, the EDP 265 may include a currently trained outcome generation function (CTOGF) defined by a selected PEAM. For example, the CTOGF may be represented by the output multiplier 285. Based on the selected PEAM, for example, the EDP engine 295 may also extract the environmental parameters 150 required by the selected PEAM. The EDP engine 295 may include the user profile 280 based on, for example, the user devices that transmit the user selection signal 200.

In some examples, the selected PEAM may be updated after the selection. In some implementations, the nature dependent response 105 may notify the users (e.g., the resource controller 110 and the resource operator 115) of whether they confirm to use an updated PEAM. If the users do not want to use the updated PEAM, the nature dependent response 105 may use the EDP to generate outcomes based on the originally and/or previously selected PEAM. For example, by saving the user profile 280, the environmental parameters 150, and the output multiplier 285 of the selected PEAM, the nature dependent response 105 may advantageously provide a technical solution to a technical problem of generating the outcomes 120a, 120b at the apportionment times using a PEAM selected at a setup time (e.g., 1, 2, 5 10 years ago).

In some implementations, the CTOGF may be manually and/or automatically adjusted based on various factors. For example, a resource controller may adjust the output multiplier 285 to allow (temporary) increase in apportionment of the resource operator. For example, the SNRS 125 may automatically adjust the output multiplier 285 based on a current event (e.g., a global pandemic) to allow relief of, for example, sudden increase in operation cost.

FIG. 2C shows an exemplary SNRS for generating an outcome 120 for a user device 215. In this example, the nature dependent response 105 includes an authentication engine 298. The authentication engine 298 receives a request signal from the user device 215. For example, the user device 215 may transmit a request to generate the outcome based on a current nature dependent response 105. For example, the authentication engine 298 may identify, based on an identification associated with the user device 215, a user profile. For example, the authentication engine 298 may identify the user profile 280 based on a user account of the device 215. Based on the user profile, the authentication engine 298 may notify the outcome generation engine 135 to retrieve the EDP 265 associated with the user profile. For example, the outcome generation engine 135 may use the EDP 265 to generate the outcome 120 associated with the user device.

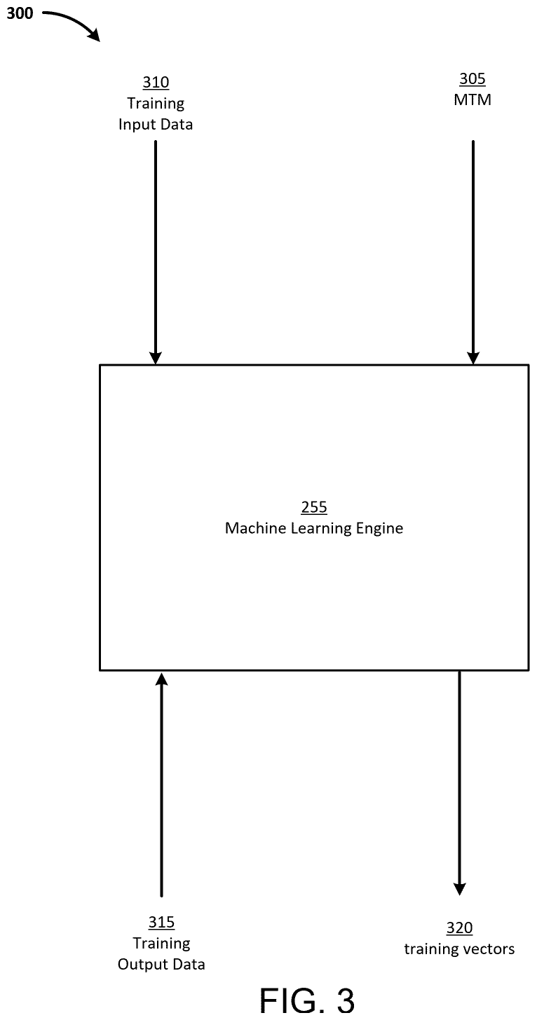

FIG. 3 is a block diagram depicting an exemplary machine learning engine of an exemplary SNRS. In a training system 300, the machine learning engine 255 may train one or more machine learning models (MTM 305). For example, the MTM 305 may include the PEAMs 130. In some examples, the one or more MTMs 305 may include the factor generation model 275. In some examples, the one or more MTMs 305 may include the UGM 290.

The MTM 305 may, by way of example and not limitation, include a neural network model. The neural network model may include, for example, recurrent neural network (RNN) and/or deep neural network (DNN). The MTM 305 may, for example, include an ensemble model. Different neural network models may be selected. The number of the model layers (e.g., the hidden neurons) may also be determined based on, for example, the complexity of content descriptions and/or attributes.

A set of training data is applied to the machine learning engine 255 to train the machine learning model. The training data includes a training input data 310 and a training output data 315. The training input data 310 may include, for example, historical data of the environmental parameters 150. The training input data 310 may include, for example, historical values of the environmental parameters 150 retrieved by the EME 240.

The set of training output data 315 may include historical response corresponding to a geographical location and/or time associated with the nature response system 100. For example, each of the PEAMs 130 may be pre-defined to be associated with a geographical local, time period, weather pattern, climate, or a combination thereof. The training output data 315 may, for example, be selected to correspond to the training input data 310. In some implementations, the training input data 310 and the training output data 315 may be selected based on the user profile 280 associated with the question. For example, the machine learning engine 255 may be used to train a nature dependent response 105 using a selected PEAM. In some examples, the training input data 310 and the training output data 315 may be selected based on time period (e.g., using data for the past 1, 2, 3-100 years) and/or based on characteristics of a location.

In some embodiments, before training, a set of testing data (including testing input data and the testing output data) may be divided from the training data. After a MTM is trained (e.g., the PEAMs 130, the factor generation model 275, the UGM 290), the testing data may be applied to the trained model to test the training accuracy of the model. For example, the trained model may receive the testing input data and generate an output data in response to the testing input data. The generated output data may be compared with the testing output data to determine the prediction accuracy (e.g., based on a predetermined criterion(s) such as a maximum error threshold). In some embodiments, one or more models (e.g., neural network models) may be cascaded together. The cascaded model may be trained and tested.

After a training process, the machine learning engine 255 generates training vectors 320, for example. In some implementations, the training vectors 320 may be used to update weighting or other parameters of the trained machine learning models.

FIG. 4A and FIG. 4B depict an exemplary predicted outcome curve 400. For example, the outcome generation engine 135 may apply the nature dependent response 105 to a selected PEAM to generate the outcomes 120a, 120b as a function of a range of response (e.g., Production per Area Unit) of a nature response system (e.g., the nature response system 100). As shown, a range of per unit costs (e.g., operating costs) of the nature response system may be generated. For example, the per unit costs may be generated based on historical environmental parameters 150. Based on the per unit cost and a corresponding response, the outcome generation engine 135 may generate the resource controller outcome based on the output multiplier 285 of the selected PEAM. For example, the resource operating outcome may be generated by subtracting the resource controller outcome from the nature dependent resource.

As shown, the resource controller outcome and the resource operator outcome are continuous. By displaying the predicted outcomes, the SNRS 125 may, for example, advantageously reduce risk. In some examples, the training (e.g., using the training system 300) of PEAM may advantageously account for volatile commodity prices, crop output, input costs and other environmental factors.

FIG. 4B depicts an exemplary cubic PEAM 405. For example, the exemplary cubic PEAM 405 may include a constant factor k. For example, k may include a number of factors included in the PEAM 405. For example, a user may select the exemplary cubic PEAM 405 based on the factors.

Here, the exemplary cubic PEAM 405 is a cubic as a function of a nature dependent response Y. For example, The Y³ term may overpower the Y² term as Y increases. For example, the exemplary cubic PEAM 405 may be designed such that an apportionment of the nature dependent response 105 for the resource controller 110 may decrease when Y exceeds a predetermined threshold associated with factors H and A.

FIG. 5 depicts an exemplary method for training a machine learning model. For example, the method 500 may be performed by the machine learning engine 255 as described with reference to FIG. 3. The method 500 begins when a signal is received to start a training process of a selected machine learning model in step 505. For example, training in a machine learning model may be triggered by an administrative user. For example, the administrative user may select to train the PEAMs 130 periodically (e.g., weekly, monthly, yearly). For example, the machine learning engine 255 may be automatically triggered to retrain the factor generation model 275 and/or the UGM 290 when a quality score of either or both of the models drops below a predetermined threshold.

Next, the selected machine learning model to be trained is retrieved in step 510. In step 515, a training data set is generated. For example, the MTM 305 may be retrieved. For example, the training data set may be generated from the historical response database 155. For example, the training data set may include the training input data 310 and the training output data 315.

In step 520, a testing data set is generated. For example, the machine learning engine 255 may generate the testing data set from the training input data 310 and the training output data 315. After the training data set and the testing data set are generated, in step 525, an updated model is generated. For example, the machine learning engine 255 may use the training input data 310 and the training output data 315 to train a machine learning model (e.g., the PEAM 130). In step 530, the updated model is evaluated by assigning a score based on objective evaluation vectors and the user engagement vectors. For example, the machine learning engine 255 may generate a quality score for an updated machine learning model based on objective factors (e.g., speed, accuracy, proper wordings) and/or subjective factors (e.g., estimated user engagement, relatedness).

In a decision point 535, it is determined whether the score is within tolerance. For example, the tolerance may be an overall score threshold. For example, the tolerance may be a set of quantitative thresholds that the updated model must meet. If the score is not within tolerance, in step 540, parameters of the training model are updated based on the score, and the step 525 is repeated. For example, the machine learning engine 255 may adjust a step size, epoch size, testing and training data sets to re-train the machine learning model. If the score is within tolerance, an update vector for the selected machine learning model is generated in step 545, and the method 500 ends. For example, the machine learning engine 255 may generate the training vectors 320 after training to update the MTM 305.

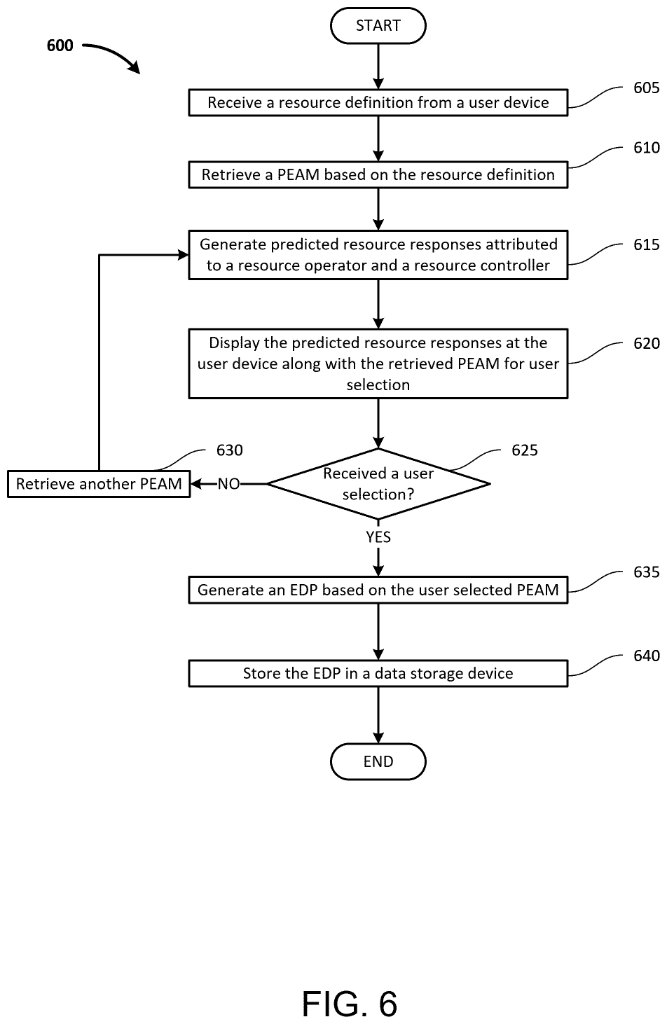

FIG. 6 depicts an exemplary pre-event apportion model (PEAM) selection method 600. For example, the SNRS 125 may perform the method 600 when the resource controller 110 and the resource operator 115 are negotiating a response apportionment of the nature response system 100. In this example, the method 600 begins in step 605 when a resource definition is received from a user device. For example, the resource definition may include a physical location of a resource. For example, the resource definition may include one or more user-defined factors. For example, the user-defined factors may include boundary conditions of the outcome 120. For example, the boundary conditions may include a minimum outcome for the nature response system 100. For example, the resource definition may include user-selected environmental parameters 150 to be included in a PEAM.

In step 610, a PEAM is retrieved based on the resource definition. For example, the UIE 250 may retrieve one of the PEAMs 130 based on the resource definition. Next, predicted resource responses attributed to a resource operator and a resource controller are generated in step 615. For example, the outcome generation engine 135 may generate the curve 145 based on the currently selected PEAM 160.

The predicted resource responses are displayed at the user device along with the retrieved PEAM for user selection in step 620. For example, the curve 145 and the currently selected PEAM 160 are displayed at the computing device 140a and the computing device 140b. Next, in a decision point 625, it is determined whether a user selection is received.

If no user selection is received, in step 630, another PEAM is retrieved, and the step 615 is repeated. For example, the SNRS 125 may retrieve another PEAM that satisfies the resource definition. If a user selection is received, an EDP is generated based on the user selected PEAM in step 635. For example, the EDP 265 may be generated by the EDP engine 295 as described with reference to FIG. 2B. In step 640, the EDP is stored in a data storage device, and the method 600 ends. For example, the EDP 265 is stored in the data store 260.

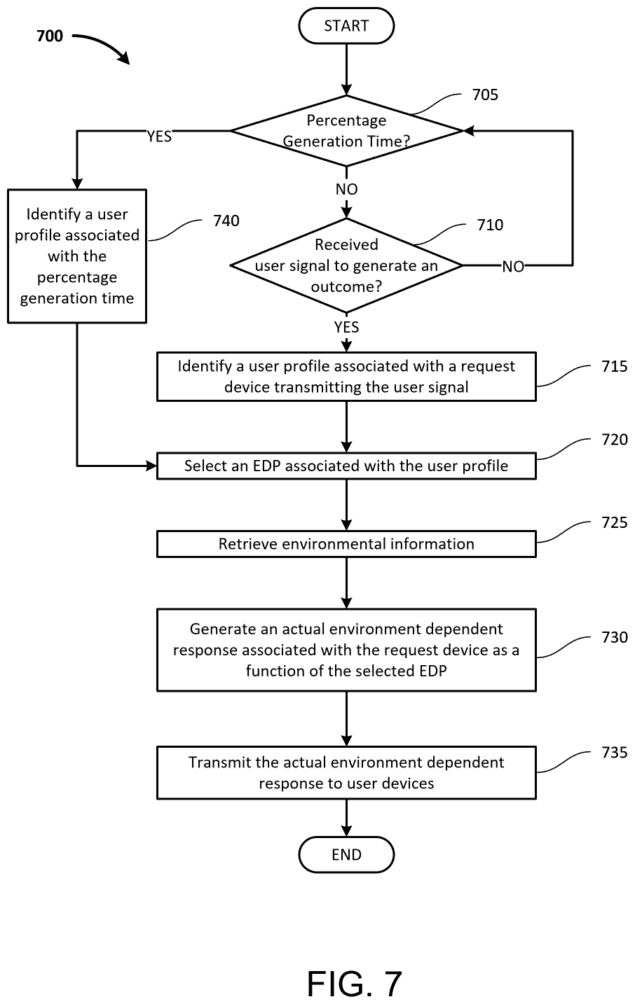

FIG. 7 depicts an exemplary resource outcome generation method 700. For example, the outcome generation engine 135 may perform the method 700 to generate the outcome 120. In this example, the method 700 begins in a decision point 705 of whether it is percentage generation time. For example, the user profile 280 of each of the EDP 265 may include a trigger time (e.g., quarterly, 6 monthly, yearly) for generating a percentage apportionment to users.

If it is not percentage generation time, it is determined whether a user signal is received to generate an outcome in a decision point 710. For example, the SNRS 125 may receive a signal from the user device 215 to generate an outcome as described with reference to FIG. 2C. If no user signal is received, the decision point 705 is repeated. If a user signal is received, in step 715, a user profile associated with a request device transmitting the user signal is identified. For example, the authentication engine 298 may identify the user profile based on a user account of the request device. In step 720, an EDP associated with the user profile is selected. For example, the outcome generation engine 135 may, upon receiving the identified user profile from the authentication engine 298, select the EDP 265 associated with the user profile 280. Next, environmental information is retrieved in step 725. For example, the EME 240 may retrieve the environmental information required by the EDP 265. For example, the environmental information may include an average nature dependent response 105 near the nature response system 100. After the environmental information is retrieved, in step 730, an actual environmental dependent response associated with the request device is generated as a function of the selected EDP. For example, the outcome generation engine 135 may apply the environmental information to the EDP 265 to generate the outcomes 120a, 120b. Next, the actual environment dependent response is transmitted to user devices in step 735 and the method 700 ends. For example, the user devices may be specified in the user profile 280.

In the decision point 705, if it is percentage generation time, in step 740, a user profile associated with the percentage generation time is identified, and the step 720 is repeated. For example, the user profile may be identified based on the EDP 265 that triggers the percentage generation time.

Although various embodiments have been described with reference to the figures, other embodiments are possible. In some implementations, the SNRS 125 may use a large language model (LLM) to guide a PEAM selection process between the resource controller 110 and the resource operator 115. For example, the SNRS 125 may include an internal LLM. For example, the SNRS 125 may include an application user interface (API) configured to use an external LLM (e.g., the fourth generation generative pre-trained transformer (GPT-4), the Language Model for Dialogue Applications (LaMDA)).

In some implementations, the SNRS 125 may be implemented in a blockchain. For example, the SNRS 125 may be run on an Ethereum virtual machine (EVM). For example, the outcome generation engine 135 may apportion the computing device 140a and the computing device 140b by subtracting a total output by a gas fee defined by the EVM.

Although an exemplary system has been described with reference to FIGS. 1-2C, other implementations may be deployed in other industrial, scientific, medical, commercial, and/or residential applications.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative example, a selective nature response system (SNRS) may include a user interface engine configured to generate a display of information at a user device and to receive user inputs. For example, the SNRS may include a non-volatile data store may include a plurality of pre-event apportionment models (PEAMs). For example, each of the PEAMs may be configured to generate a resource outcome for a resource operator and a resource controller of a resource as a function of environmental parameters may include factors associated with the resource outcome. For example, user-defined parameters may include boundary conditions of the resource response. For example, the SNRS may include a factor generation engine may include a trained natural factor processing model configured to generate the environmental parameters. For example, in a configuration mode, at least some of the environmental parameters may be selected to generate the plurality of PEAMs to be stored in the data store. For example, the SNRS may include an environmental monitoring engine that may be configured to retrieve environmental information associated with the PEAMs, the environmental information relating to a physical location of the resource. For example, the plurality of PEAMs may be trained with historical environmental information retrieved by the environmental monitoring engine.

For example, an outcome generation engine may be configured to perform a percentage generation operation to automatically determine an actual environment dependent response for the resource operator and the resource controller based on actual environmental information at a percentage generation time, the operation may include generate a plurality of predicted resource responses corresponding to the PEAMs to the resource operator and the resource controller. For example, the operation may include display, using the user interface engine, the plurality of predicted resource responses for selection. For example, the operation may include receiving, from the user interface engine, a selection of one of the PEAMs by the resource operator and the resource controller. For example, the operation may include generating an environmental dynamic package (EDP) based on the selection. For example, the EDP may include a user profile associated with the user device, an outcome multiplier may include an outcome generation function defined by the selected PEAM. For example, the environmental parameters as a function of the selected PEAM. For example, at the percentage generation time, apply the environmental information retrieved by the environmental monitoring engine to the EDP to generate the actual environment dependent response for the resource controller and the resource operator.

For example, the resource operator may include a land operator. For example, the resource controller may include a landowner. For example, the resource outcome may include a crop production in a time period. For example, the resource may include farmland. The SNRS may include an authentication engine configured to perform authentication operations.

For example, the authentication operations may include identify, based on an identification of associated with a request device, a user profile associated with the request device. For example, select an EDP associated with the user profile, such that the outcome generation engine uses the selected EDP to generate the actual environment dependent response associated with the request device.

For example, the factor generation engine may include a large language model (LLM). For example, the user-defined parameters comprise a minimum environment dependent response apportioned to the resource controller. For example, the outcome generation function may include a cubic equation for generating the actual environment dependent response. For example, the environmental parameters comprise nature induced conditions may include rainfall and temperature around a proximity of the physical location of the resource. For example, the environmental parameters comprise economic induced conditions may include a price of the response outcome and operating costs of the resource.

In an illustrative example, a computer program product (CPP) may include a program of instructions tangibly embodied on a non-transitory computer readable medium wherein, when the instructions may be executed on a processor, the processor causes resource apportionment configuration operations in a configuration time to be performed to automatically determine an actual environment dependent response for a resource operator and a resource controller based on actual environmental information at a percentage generation time, the operations may include receive, from a user device, a resource definition may include a physical location of the resource. For example, the resource generates an environment dependent response.

For example, the operation may include retrieving a pre-event apportionment model (PEAM) based on the resource definition from a plurality of PEAMs. For example, the PEAM may include environmental parameters and user-defined parameters may include boundary conditions of a resource outcome for the resource operator and the resource controller. For example, the environmental parameters comprise factors associated with the resource outcome. For example, the factors may be generated by a trained natural factor processing model.

For example, the operation may include generating predicted resource outcomes attributed to the resource operator and the resource controller corresponding to the retrieved PEAM. For example, the predicted resource outcomes may be generated as a function of historical environmental parameters and the user-defined parameters. For example, the operation may include displaying the predicted resource responses at the user device along with the retrieved PEAM for user selection.

For example, the operation may include receiving a signal representing a selection of the PEAM from the user device. For example, the operation may include generating an environmental dynamic package (EDP) based on the selection. For example, the EDP may include a user profile associated with the user device, an outcome multiplier. For example, the environmental parameters as a function of the selected PEAM. For example, the outcome multiplier may include an outcome generation function defined by the selected PEAM. For example, at the percentage generation time, retrieve environmental information. For example, the environmental information relates to the physical location of the resource. For example, the plurality of PEAMs may be trained with historical environmental information.

For example, the operation may include applying the retrieved environmental information to the EDP to generate the actual environment dependent response for the resource controller and the resource operator.

For example, the operations may include identify, based on an identification of associated with a request device, a user profile associated with the request device. For example, the operation may include selecting an EDP associated with the user profile. For example, the operation may include generating the actual environment dependent response associated with the request device as a function of the selected EDP.

For example, the trained natural factor processing model may include a large language model (LLM). For example, the user-defined parameters comprise a minimum environment dependent response apportioned to the resource controller. For example, the outcome generation function may include a cubic equation for generating the actual environment dependent response.

In an illustrative aspect, a computer-implemented method performed by at least one processor to automatically determine an actual environment dependent response for a resource operator and a resource controller based on actual environmental information at a percentage generation time, the method may include receive, from a user device, a resource definition may include a physical location of the resource. For example, the resource generates an environment dependent response. For example, the operation may include retrieving a pre-event apportionment model (PEAM) based on the resource definition from a plurality of PEAMs. For example, the PEAM may include environmental parameters and user-defined parameters may include boundary conditions of a resource outcome. For example, the environmental parameters comprise factors associated with the resource outcome. For example, the factors may be generated by a trained natural factor processing model.

For example, the operation may include generating predicted resource outcome attributed to a resource operator and a resource controller corresponding to the retrieved PEAM. For example, the predicted resource outcome may be generated as a function of historical environmental parameters and the user-defined parameters. For example, the operation may include displaying the predicted resource responses at the user device along with the retrieved PEAM for user selection; receive a signal representing a selection of the PEAM from the user device. For example, the operation may include generating an environmental dynamic package (EDP) based on the selection. For example, the EDP may include a user profile associated with the user device, an outcome multiplier. For example, the environmental parameters as a function of the selected PEAM. For example, the outcome multiplier may include an outcome generation function defined by the selected PEAM. For example, the operation may include at the percentage generation time, retrieve environmental information. For example, the environmental information relates to a physical location of the resource. For example, the plurality of PEAMs may be trained with historical environmental information. For example, the operation may include applying the retrieved environmental information to the EDP to generate an actual environment dependent response for the resource controller and the resource operator.

The computer-implemented method may include identify, based on an identification of associated with a request device, a user profile associated with the request device. The method may include, for example, select an EDP associated with the user profile. For example, the method may include generating the actual environment dependent response associated with the request device as a function of the selected EDP.

For example, the trained natural factor processing model may include a large language model (LLM). For example, the user-defined parameters comprise a minimum environment dependent response apportioned to the resource controller. For example, the outcome generation function may include a cubic equation for generating the actual environment dependent response.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A selective nature response system (SNRS) comprising:
a user interface engine configured to generate a display of information at a user device and to receive user inputs;
a non-volatile data store comprising a plurality of pre-event apportionment models (PEAMs), wherein each of the PEAMs is configured to generate a resource outcome for a resource operator and a resource controller of a resource as a function of environmental parameters comprising factors associated with the resource outcome, and user-defined parameters comprising boundary conditions of the resource response;
a factor generation engine comprising a trained natural factor processing model configured to generate the environmental parameters, wherein, in a configuration mode, at least some of the environmental parameters are selected to generate the plurality of PEAMs to be stored in the data store;
an environmental monitoring engine configured to retrieve environmental information associated with the PEAMs, the environmental information relating to a physical location of the resource, wherein the plurality of PEAMs are trained with historical environmental information retrieved by the environmental monitoring engine; and,
an outcome generation engine configured to perform a percentage generation operation to automatically determine an actual environment dependent response for the resource operator and the resource controller based on actual environmental information at a percentage generation time, the operation comprising:
generate a plurality of predicted resource responses corresponding to the PEAMs to the resource operator and the resource controller;
display, using the user interface engine, the plurality of predicted resource responses for selection;
receive, from the user interface engine, a selection of one of the PEAMs by the resource operator and the resource controller;
generate an environmental dynamic package (EDP) based on the selection, wherein the EDP comprises a user profile associated with the user device, an outcome multiplier comprising an outcome generation function defined by a selected PEAM from the selection of one of the PEAMs, and the environmental parameters as a function of the selected PEAM; and,
at the percentage generation time, apply the environmental information retrieved by the environmental monitoring engine to the EDP to generate the actual environment dependent response for the resource controller and the resource operator.

2. The SNRS of claim 1, wherein the resource operator comprises a land operator, and the resource controller comprises a landowner.

3. The SNRS of claim 1, wherein the resource outcome comprises a crop production in a time period.

4. The SNRS of claim 1, wherein the resource comprises farmland.

5. The SNRS of claim 1, further comprising an authentication engine configured to perform authentication operations, wherein the authentication operations comprise:
identify, based on an identification of associated with a request device, a user profile associated with the request device; and,
select an EDP associated with the user profile, such that the outcome generation engine uses the selected EDP to generate the actual environment dependent response associated with the request device.

6. The SNRS of claim 1, wherein the factor generation engine comprises a large language model (LLM).

7. The SNRS of claim 1, wherein the user-defined parameters comprise a minimum environment dependent response apportioned to the resource controller.

8. The SNRS of claim 1, wherein the outcome generation function comprises a cubic equation for generating the actual environment dependent response.

9. The SNRS of claim 1, wherein the environmental parameters comprise nature induced conditions comprising rainfall and temperature around a proximity of the physical location of the resource.

10. The SNRS of claim 1, wherein the environmental parameters comprise economic induced conditions comprising a price of the response outcome and operating costs of the resource.

11. A computer program product (CPP) comprising a program of instructions tangibly embodied on a non-transitory computer readable medium wherein, when the instructions are executed on a processor, the processor causes resource apportionment configuration operations in a configuration time to be performed to automatically determine an actual environment dependent response for a resource operator and a resource controller based on actual environmental information at a percentage generation time, the operations comprising:
receive, from a user device, a resource definition comprising a physical location of the resource, wherein the resource generates an environment dependent response;
retrieve a pre-event apportionment model (PEAM) based on the resource definition from a plurality of PEAMs, wherein the PEAM comprises environmental parameters and user-defined parameters comprises boundary conditions of a resource outcome for the resource operator and the resource controller, wherein the environmental parameters comprise factors associated with the resource outcome, wherein the factors are generated by a trained natural factor processing model;
generate predicted resource outcomes attributing to the resource operator and the resource controller corresponding to the retrieved PEAM, wherein the predicted resource outcomes are generated as a function of historical environmental parameters and the user-defined parameters;
display the predicted resource responses at the user device along with the retrieved PEAM for user selection;
receive a signal representing a selection of the PEAM from the user device; and,
generate an environmental dynamic package (EDP) based on the selection, wherein the EDP comprises a user profile associated with the user device, an outcome multiplier, and the environmental parameters as a function of the selected PEAM, wherein the outcome multiplier comprises an outcome generation function defined by the selected PEAM, such that,
at the percentage generation time, retrieve environmental information, wherein the environmental information relates to the physical location of the resource, wherein the plurality of PEAMs are trained with historical environmental information, and,
apply the retrieved environmental information to the EDP to generate the actual environment dependent response for the resource controller and the resource operator.

12. The CPP of claim 11, wherein the operations further comprise:
identify, based on an identification of associated with a request device, a user profile associated with the request device;
select an EDP associated with the user profile; and,
generate the actual environment dependent response associated with the request device as a function of the selected EDP.

13. The CPP of claim 11, wherein the trained natural factor processing model comprises a large language model (LLM).

14. The CPP of claim 11, wherein the user-defined parameters comprise a minimum environment dependent response apportioned to the resource controller.

15. The CPP of claim 11, wherein the outcome generation function comprises a cubic equation for generating the actual environment dependent response.

16. A computer-implemented method performed by at least one processor to automatically determine an actual environment dependent response for a resource operator and a resource controller based on actual environmental information at a percentage generation time, the method comprising:
receive, from a user device, a resource definition comprising a physical location of the resource, wherein the resource generates an environment dependent response;
retrieve a pre-event apportionment model (PEAM) based on the resource definition from a plurality of PEAMs, wherein the PEAM comprises environmental parameters and user-defined parameters comprises boundary conditions of a resource outcome, wherein the environmental parameters comprise factors associated with the resource outcome, wherein the factors are generated by a trained natural factor processing model;
generate predicted resource outcome attributing to a resource operator and a resource controller corresponding to the retrieved PEAM, wherein the predicted resource outcome are generated as a function of historical environmental parameters and the user-defined parameters;
display the predicted resource responses at the user device along with the retrieved PEAM for user selection;
receive a signal representing a selection of the PEAM from the user device; and,
generate an environmental dynamic package (EDP) based on the selection, wherein the EDP comprises a user profile associated with the user device, an outcome multiplier, and the environmental parameters as a function of the selected PEAM, wherein the outcome multiplier comprises an outcome generation function defined by the selected PEAM, such that,
at the percentage generation time, retrieve environmental information, wherein the environmental information relates to a physical location of the resource, wherein the plurality of PEAMs are trained with historical environmental information, and,
apply the retrieved environmental information to the EDP to generate an actual environment dependent response for the resource controller and the resource operator.

17. The computer-implemented method of claim 16, further comprising:
identify, based on an identification of associated with a request device, a user profile associated with the request device;
select an EDP associated with the user profile; and,
generate the actual environment dependent response associated with the request device as a function of the selected EDP.

18. The computer-implemented method of claim 16, wherein the trained natural factor processing model comprises a large language model (LLM).

19. The computer-implemented method of claim 16, wherein the user-defined parameters comprise a minimum environment dependent response apportioned to the resource controller.

20. The computer-implemented method of claim 16, wherein the outcome generation function comprises a cubic equation for generating the actual environment dependent response.
